(19) United States
(12) Patent Application Publication
(10) Pub. No.: US 2026/0204758 A1
(43) Pub. Date: Jul. 16, 2026

(54) SECONDARY BATTERY AND METHOD FOR MANUFACTURING SECONDARY BATTERY

(71) Applicants: Hyundai Motor Company, Seoul (KR); Kia Corporation, Seoul (KR)

(72) Inventors: Hyun Chang Kang, Hwaseong-si (KR); Jeong Hun Seo, Hwaseong-si (KR); In Gook Son, Hwaseong-si (KR); Jae Hoon Choi, Hwaseong-si (KR); Jun Seok Choi, Hwaseong-si (KR)

(21) Appl. No.: 19/297,998

(22) Filed: Aug. 12, 2025

(30) Foreign Application Priority Data
Jan. 7, 2025 (KR) 10-2025-0002490

(51) Int. Cl. H01M 50/593; H01M 10/04; H01M 50/105; H01M 50/178; H01M 50/54

(52) U.S. Cl. CPC H01M 50/593; H01M 10/0459; H01M 50/105; H01M 50/178; H01M 50/54

(57) ABSTRACT

Disclosed is a secondary battery including an outer casing, a plurality of electrode stacks provided in an interior of the outer casing, and a refractory insulation sheet disposed between the plurality of electrode stacks.

### CROSS-REFERENCE TO RELATED APPLICATIONS

This application claims the benefit of priority to Korean Patent Application No. 10-2025-0002490, filed in the Korean Intellectual Property Office on Jan. 7, 2025, the entire contents of which are incorporated herein by reference.

### TECHNICAL FIELD

The present disclosure relates to a secondary battery, and a method for manufacturing the same.

### BACKGROUND

Recently, as awareness of the crisis of environments and petroleum resource depletion has increased, research and development on electric vehicles that are eco-friendly vehicles have emerged. The electric vehicles include plug-in hybrid electric vehicles (PHEVs), battery electric vehicles (BEVs), and fuel cell electric vehicles (FCEVs).

The electric vehicles use battery cells in the form of secondary batteries as power sources, and, recently, efforts to increase the capacity of battery cells accommodated in the electric vehicle have continued.

To improve the capacity of the secondary battery, the energy density of the secondary battery may be improved. Meanwhile, the secondary battery may be vulnerable to a thermal runaway, and the need for the secondary battery to prevent a thermal runaway is increasing.

### SUMMARY

The present disclosure has been made to solve the above-mentioned problems occurring in the prior art while advantages achieved by the prior art are maintained intact.

An aspect of the present disclosure provides a secondary battery including a plurality of electrode stacks, by which the electrode stacks provided in an interior of an outer casing may be separated from each other.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a secondary battery may include an outer casing, a plurality of electrode stacks provided in an interior of the outer casing, and a refractory insulation sheet disposed between the plurality of electrode stacks.

The plurality of electrode stacks may include a first electrode stack including a (1-1)-th electrode having a (1-1)-th electrode tab protruding to a first side, a (1-2)-th electrode provided to have a different polarity from that of the (1-1)-th electrode and having a (1-2)-th electrode tab protruding to a second side, and a first separator disposed between the (1-1)-th electrode and the (1-2)-th electrode and that surrounds the (1-1)-th electrode and the (1-2)-th electrode together on an first outside, and a second electrode stack including a (2-1)-th electrode provided to have a polarity corresponding to the (1-1)-th electrode and having a (2-1)-th electrode tab protruding to the first side, a (2-2)-th electrode provided to a different polarity from that of the (2-1)-th electrode and having a (2-2)-th electrode tab protruding to the second side, and a second separator disposed between the (2-1)-th electrode and the (2-2)-th electrode and that surrounds the (2-1)-th electrode and the (2-2)-th electrode together on an second outside.

The secondary battery may include a first lead part connected to the (1-1)-th electrode tab and the (2-1)-th electrode tab, and a second lead part connected to the (1-2)-th electrode tab and the (2-2)-th electrode tab.

The first separator may extend to surround the (1-1)-th electrode and the (1-2)-th electrode together at least one time.

The first separator may extend to surround the (1-1)-th electrode and the (1-2)-th electrode together at least two times.

The first separator may include a (1-1)-th separator area disposed between the (1-1)-th electrode and the (1-2)-th electrode, and a (1-2)-th separator area extending from the (1-1)-th separator area and that surrounds the (1-1)-th electrode, the (1-2)-th electrode, and the (1-1)-th separator area together on an outside.

The (1-2)-th separator area may include a (1-2)-th inner separator area connected to the (1-1)-th separator area, and a (1-2)-th outer separator area extending from the (1-2)-th inner separator area and extending to surround the (1-2)-th inner separator area on an outside of the (1-2)-th inner separator area.

The refractory insulation sheet may have a size being greater than a first size of a surface of the first separator, which faces the refractory insulation sheet, and a second size of a surface of the second separator, which faces the refractory insulation sheet.

The refractory insulation sheet may protrude further than the first separator and the second separator with respect to a first direction, in which the (1-1)-th electrode tab or the (1-2)-th electrode tab protrudes, and may protrude further than the first separator and the second separator with respect to a second direction crossing the first direction.

The refractory insulation sheet may have a first thickness being greater than a second thickness of the first separator or a third thickness of the second separator with respect to a direction, in which the plurality of electrode stacks is stacked.

The first electrode stack further may include a cover sheet disposed on an third outside of the first separator and extending to surround the first separator.

The cover sheet may protrude further than the first separator with respect to a first direction, in which the (1-1)-th electrode tab or the (1-2)-th electrode tab protrudes.

The cover sheet may be formed of a refractory insulation material.

The outer casing may include a pouch type outer casing.

The refractory insulation sheet may surround the first separator and the second separator on an outside of the first separator and the second separator.

According to an aspect of the present disclosure, a method for manufacturing a secondary battery may include stacking a plurality of electrode stacks each including a plurality of electrodes and a separator disposed between the plurality of electrodes, and surrounding the electrode stacks on an outside of the electrode stacks by using the separators disposed between the plurality of electrodes, disposing a refractory insulation sheet between the plurality of electrode stacks, and surrounding the plurality of electrode stacks and the refractory insulation sheet with an outer casing.

The plurality of electrode stacks further may include a cover sheet disposed on an outside of the separator and that surrounds the separator, and the method further may include surrounding the separator with the cover sheet after the separator surrounds the electrode stacks.

According to an aspect of the present disclosure, a secondary battery includes an outer casing, a first electrode stack provided in an interior of the outer casing, wherein the first electrode stack comprises a first electrode comprising a first electrode tab, a second electrode comprising a second electrode tab and a first separator disposed, in part, between the first electrode and the second electrode, and the first electrode and the second electrode have different polarities, and a second electrode stack provided in the interior of the outer casing, wherein the second electrode stack comprises a third electrode comprising a third electrode tab, a fourth electrode comprising a fourth electrode tab and a second separator disposed, in part, between the third electrode and the fourth electrode, and the third electrode and the fourth electrode have different polarities.

The secondary battery may further include a refractory insulation sheet disposed between the first electrode stack and the second electrode stack in the interior of the outer casing.

The refractory insulation sheet may have a size being greater than a first size of a first surface of the first separator, which faces the refractory insulation sheet, and a second size of a second surface of the second separator, which faces the refractory insulation sheet.

### BRIEF DESCRIPTION OF THE DRAWINGS

The above and other aspects, features and advantages of the present disclosure will be more apparent from the following detailed description taken in conjunction with the accompanying drawings:

FIG. 1 is a perspective view of a secondary battery according to an embodiment of the present disclosure;

FIG. 2 is an exploded perspective view of an electrode stack, an outer casing, and first and second lead parts according to an embodiment of the present disclosure;

FIG. 3 is a vertical cross-sectional view of a (1-1)-th electrode tab of a first electrode stack, a (2-1)-th electrode tab of a second electrode stack, and a first lead part according to an embodiment of the present disclosure;

FIG. 4 is a vertical cross-sectional view of portion A-A′ illustrated in FIG. 2;

FIG. 5 is an exploded perspective view of a first electrode stack, a second electrode stack, and a refractory insulation sheet according to another embodiment of the present disclosure;

FIG. 6 is a vertical cross-sectional view of a first electrode stack, a second electrode stack, and a refractory insulation sheet according to another embodiment of the present disclosure;

FIG. 7 is a plan view of a first separator and a refractory insulation sheet according to another embodiment of the present disclosure;

FIG. 8 is a perspective view of a first electrode stack and a second electrode stack according to another embodiment of the present disclosure;

FIG. 9 is a vertical cross-sectional view of a first electrode stack and a second electrode stack according to another embodiment of the present disclosure; and

FIG. 10 is a flowchart of a method for manufacturing a secondary battery according to an embodiment of the present disclosure.

### DETAILED DESCRIPTION OF ILLUSTRATIVE EMBODIMENTS

Hereinafter, some embodiments of the present disclosure will be described in detail with reference to the accompanying drawings. In adding reference numerals to the components of the drawings, it should be noted that the same components have the same numerals as possible even when they are illustrated on different drawings. Furthermore, in describing the embodiments of the present disclosure, detailed descriptions associated with well-known functions or configurations will be omitted if they may make subject matters of the present disclosure unnecessarily obscure.

In describing components of embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

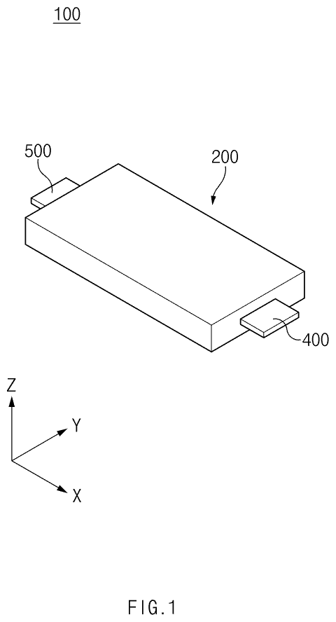

Hereinafter, various embodiments of the present disclosure will be described in detail with reference to FIGS. 1 to 10.

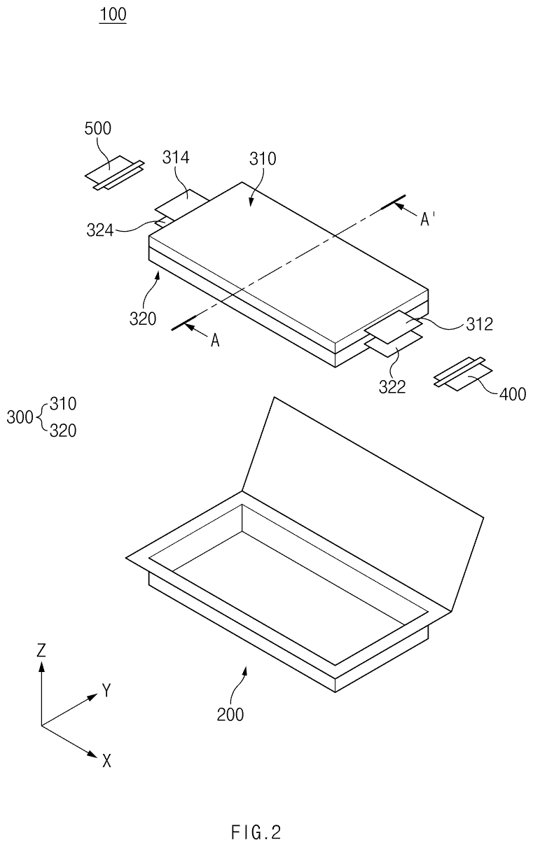

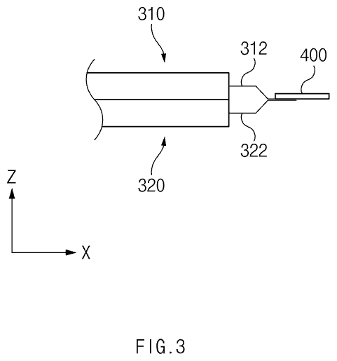

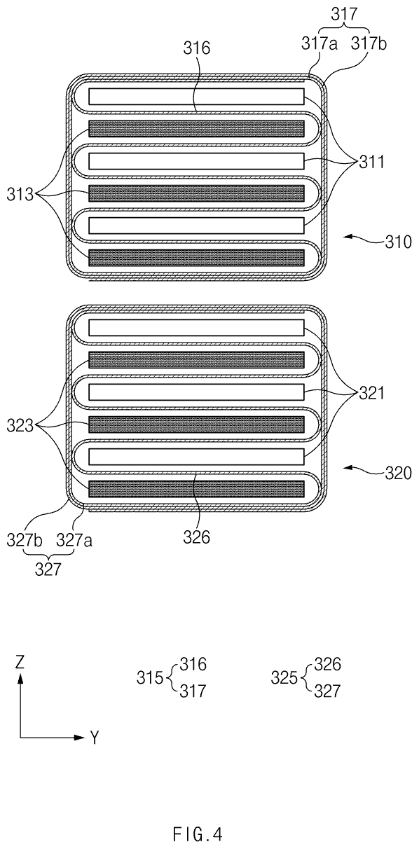

FIG. 1 is a perspective view of a secondary battery according to an embodiment of the present disclosure. FIG. 2 is an exploded perspective view of an electrode stack, an outer casing, and first and second lead parts according to an embodiment of the present disclosure. FIG. 3 is a vertical cross-sectional view of a (1-1)-th electrode tab of a first electrode stack, a (2-1)-th electrode tab of a second electrode stack, and a first lead part according to an embodiment of the present disclosure. FIG. 4 is a vertical cross-sectional view of portion A-A′ illustrated in FIG. 2.

Referring to FIGS. 1 to 4, a secondary battery 100 may include an outer casing 200, an electrode stack 300 that is accommodated in an interior of the outer casing 200, and first and second lead parts 400 and 500 that are connected to the electrode stack 300, respectively.

The outer casing 200 may be provided as a pouch type outer casing to accommodate the electrode stack 300, but the present disclosure is not limited thereto. An electrolyte may be injected into the outer casing 200 and then be sealed after the electrode stack 300 is accommodated in an interior thereof.

Meanwhile, to increase an energy density of the secondary battery 100, the electrode stack 300 may be accommodated in the interior of the outer casing 200 with a plurality of electrodes stacked. For example, when a fire occurs in any one electrode while the plurality of electrodes is stacked in the interior of the outer casing 200, a thermal transfer or a thermal runaway may occur in all of the plurality of electrodes, and thus, a safety of the secondary battery 100 may deteriorate.

According to the secondary battery 100 according to the present disclosure, the outer casing 200 and the plurality of electrode stacks 300 that are physically spaced apart from each other in one outer casing 200 may be included.

More specifically, the electrode stack 300 may include a first electrode stack 310 and a second electrode stack 320.

The first electrode stack 310 may be provided in the interior of the outer casing 200, and may include a (1-1)-th electrode 311, a (1-2)-th electrode 313 that is provided to have a different polarity from that of the (1-1)-th electrode 311, and a first separator 315. As an example, the (1-1)-th electrode 311 may be provided as a negative electrode, and the (1-2)-th electrode 313 may be provided as a positive electrode.

The second electrode stack 320 may be provided in the interior of the outer casing 200, and may include a (2-1)-th electrode 321 that is provided to have a polarity corresponding to the (1-1)-th electrode 311, a (2-2)-th electrode 323 that is provided to have a different polarity from that of the (2-1)-th electrode 321, and a second separator 325.

The (1-1)-th electrode 311 may include a (1-1)-th electrode tab 312 that protrudes to a first side (the “X” direction) in the first direction, and the (1-2)-th electrode 313 may include a (1-2)-th electrode tab 314 that protrudes to a second side (an opposite direction to the “X” direction) in the first direction.

The first separator 315 may be disposed between the (1-1)-th electrode 311 and the (1-2)-th electrode 313, and may be configured to surround the (1-1)-th electrode 311 and the (1-2)-th electrode 313 on an outside. For example, the first separator 315 may not surround the (1-1)-th electrode tab 312 or the (1-2)-th electrode tab 314.

The electrode stack 320 may be disposed on one side (an opposite to the “Z” direction) of the first electrode stack 310 in the second direction in the interior of the outer casing 200. The (2-1)-th electrode 321 of the second electrode stack 320 may include a (2-1)-th electrode tab 322 that protrudes to a first side in the first direction, and the (2-2)-th electrode 323 may include a (2-2)-th electrode tab 324 that protrudes to a second side in the first direction.

The separator 325 may be disposed between the (2-1)-th electrode 321 and the (2-2)-th electrode 323, and may be configured to surround the (2-1)-th electrode 321 and the (2-2)-th electrode 323 on the outside. For example, the second separator 325 may not surround the (2-1)-th electrode tab 322 or the (2-2)-th electrode tab 324.

The first electrode stack 310 and the second electrode stack 320 may be formed to be spaced apart from each other in the second direction (the “Z” direction or an opposite direction to the “Z” direction). This may be to prevent a thermal runaway of the secondary battery 100 by delaying a thermal transfer from any one of the first electrode stack 310 and the second electrode stack 320 to the other even when a fire occurs.

Meanwhile, the first and second lead parts 400 and 500 of the secondary battery 100 may pass through an outside of the outer casing 200 and an inside of the outer casing 200. A first lead part 400 may be disposed on a first side(the “X” direction) of the outer casing 200 in the first direction to be connected to the (1-1)-th electrode tab 312 and the (2-1)-th electrode tab 322. A second lead part 500 may be disposed on a second side (an opposite direction to the “X” direction) of the outer casing 200 in the first direction to be connected to the (1-2)-th electrode tab 314 and the (2-2)-th electrode tab 324.

More specifically, the first lead part 400 may be welded to both of the (1-1)-th electrode tab 312 and the (2-1)-th electrode tab 322. Furthermore, the second lead part 500 may be welded to both of the (1-2)-th electrode tab 314 and the (2-2)-th electrode tab 324.

According to this structure, after the first and second electrode stacks 310 and 320 are stacked in the second direction, the first lead part 400 may be welded to the (1-1)-th and (2-1)-th electrode tabs 312 and 322 at one time, and the second lead part 500 may be welded to the (1-2)-th and (2-2)-th electrode tabs 314 and 324 at one time. Accordingly, the lead parts 400 and 500 corresponding to the number of the first and second electrode stacks 310 and 320 are not required, and, thus a productivity of the secondary battery 100 may be improved.

Meanwhile, the drawing illustrates that the first and second electrode stacks 310 and 320 divided into two are inserted into the outer casing 200, but the present disclosure is not limited thereto, and a plurality of electrode stacks 300 may be inserted into the outer casing 200.

Furthermore, each of the first and second electrode stacks 310 and 320 may include a plurality of electrodes 311, 313, 321, and 323. The (1-1)-th electrode 311 and the (1-2)-th electrode 313 may be provided to have different polarities and may be alternately arranged in the second direction. Similarly, the (2-1)-th electrode 321 and the (2-2)-th electrode 323 may be provided to have different polarities and may be alternately arranged in the second direction.

The first separator 315 may extend to surround the (1-1)-th electrode 311 and the (1-2)-th electrode 313 on the outside at least one time when viewed in the first direction. The first separator 315 in FIG. 4 may extend to surround the (1-1)-th electrode 311 and the (1-2)-th electrode 313 on the outside at least two times.

The first separator 315 may include a (1-1)-th separator area 316 that is disposed between the (1-1)-th electrode 311 and the (1-2)-th electrode 313, and a (1-2)-th separator area 317 that extends from the (1-1)-th separator area 316 and is configured to surround the (1-1)-th electrode 311, the (1-2)-th electrode 313, and the (1-1)-th separator area 316 together on the outside.

The (1-2)-th separator area 317 may include a (1-2)-th inner separator area 317a that is connected to the (1-1)-th separator area 316, and a (1-2)-th outer separator area 317b that extends from the (1-2)-th inner separator area 317a and extends to surround the (1-2)-th inner separator area 317a on the outside of the (1-2)-th inner separator area 317a.

The second separator 325 of the second electrode stack 320 may also correspond to a shape of the first separator 315. More specifically, the second separator 325 may extend to surround the (2-1)-th electrode 321 and the (2-2)-th electrode 323 at least one time on the outside when viewed in the first direction. The second separator 325 in FIG. 4 may extend to surround the (2-1)-th electrode 321 and the (2-2)-th electrode 323 on the outside at least two times.

The second separator 325 may include a (2-1)-th separator area 326 that is disposed between the (2-1)-th electrode 321 and the (2-2)-th electrode 323, and a (2-2)-th separator area 327 that extends from the (2-1)-th separator area 326 and is configured to surround the (2-1)-th electrode 321, the (2-2)-th electrode 323, and the (2-1)th separator area 326 together from the outside.

The (2-2)-th separator area 327 may include a (2-2)-th inner separator area 327a that is connected to the (2-1)-th separator area 326, and a (2-2)-th outer separator area 327b that extending from the (2-2)-th inner separator area 327a and extends to surround the (2-2)-th inner separator area 327a on the outside of the (2-2)-th inner separator area 327a.

The first separator 315 of the first electrode stack 310 may surround the (1-1)-th electrode 311 and the (1-2)-th electrode 313 on the outside at least two times, and the second separator 325 of the second electrode stack 320 may surround the (2-1)-th electrode 321 and the (2-2)-th electrode 323 on the outside at least two times. According to this structure, exchange of ions between the first electrode stack 310 and the second electrode stack 320 may be relatively prevented, and thus, even when a fire occurs in any one of the first and second electrode stacks 310 and 320 in an interior of the secondary battery 100, a fire may be prevented from occurring in the other.

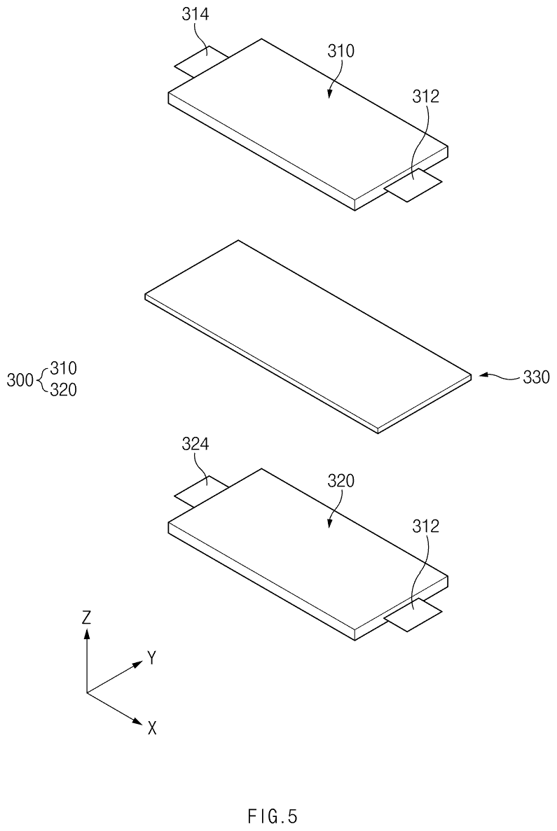

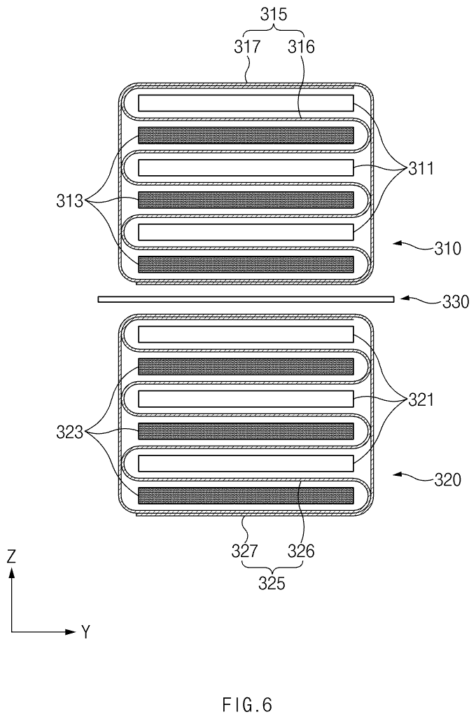

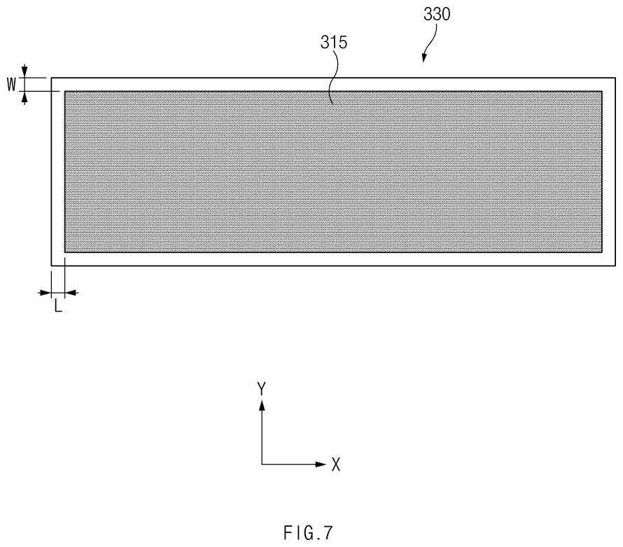

Accordingly, a thermal runaway that may occur in an interior of the secondary battery 100 may be prevented, and thus, the safety of the secondary battery 100 may be improved. FIG. 5 is a perspective view of a first electrode stack, a second electrode stack, and a refractory insulation sheet according to another embodiment of the present disclosure. FIG. 6 is a vertical cross-sectional view of a first electrode stack, a second electrode stack, and a refractory insulation sheet according to another embodiment of the present disclosure. FIG. 7 is a plan view of a first separator and a refractory insulation sheet according to another embodiment of the present disclosure.

Referring to FIGS. 5 to 7, a secondary battery 100 according to another embodiment of the present disclosure may further include a first electrode stack 310, a second electrode stack 320, and a refractory insulation sheet 330 that is disposed between the first electrode stack 310 and the second electrode stack 320.

Unlike in the first and second electrode stacks 310 and 320 according to an embodiment of the present disclosure illustrated in FIG. 4, in the first and second electrode stacks 310 and 320 according to an embodiment of the present disclosure, the first and second separators 315 and 325 may be configured to surround the (1-1)-th and (1-2)-th electrodes 311 and 313 or the (2-1)-th and (2-2)-th electrodes 321 and 323 on the outside at least one time.

For a description of the (1-1)-th, (1-2)-th, (2-1)-th, and (2-2)-th electrodes 311, 313, 321, and 323 according to an embodiment of the present disclosure, the descriptions of the (1-1)-th, (1-2)-th, (2-1)-th, and (2-2)-th electrodes 311, 313, 321, and 323 according to an embodiment of the present disclosure are used.

The secondary battery 100 according to another embodiment of the present disclosure may further include a refractory insulation sheet 330. The refractory insulation sheet 330 may be disposed between electrode stacks of a plurality of electrode stacks 300. As an example, the refractory insulation sheet 330 may be disposed between the first electrode stack 310 and the second electrode stack 320 to relatively prevent exchange of ions between the first electrode stack 310 and the second electrode stack 320. For example, the refractory insulation sheet 330 may be formed of a refractory material and an insulation material.

The first separator 315 of the first electrode stack 310 may include a (1-1)-th separator area 316 that is disposed between the (1-1)-th electrode 311 and the (1-2)-th electrode 313, and a (1-2)-th separator area 317 that extends from the (1-1)-th separator area 316 and is configured to surround the (1-1)-th electrode 311, the (1-2)-th electrode 313, and the (1-1)-th separator area 316 on the outside at least one time.

Due to the configuration of the refractory insulation sheet 330, the (1-2)-th separator area 317 according to another embodiment of the present disclosure may surround the (1-1)-th electrode 311, the (1-2)-th electrode 313, and the (1-1)-th separator area 316 on the outside one time, unlike the (1-2)-th separator area 317 according to an embodiment of the present disclosure.

Furthermore, in correspondence to the first electrode stack 310, the second separator 325 of the second electrode stack 320 may include a (2-1)-th separator area 326 that is disposed between the (2-1)-th electrode 321 and the (2-2)-th electrode 323, and a (2-2)-th separator area 327 that extends from the (2-1)-th separator area 326 and is configured to surround the (2-1)-th electrode 321, the (2-2)-th electrode 323, and the (2-1)th separator area from the outside at least one time.

The (2-2)-th separator area 327 according to another embodiment of the present disclosure may surround the (2-1)-th electrode 321, the (2-2)-th electrode 323, and the (2-1)-th separator area 326 on the outside one time, unlike the (2-2)-th separator area 327 according to an embodiment of the present disclosure, due to the configuration of the refractory insulation sheet 330.

However, the present disclosure is not limited thereto, and the (1-2)-th and (2-2)-th separator areas 317 and 327 according to another embodiment of the present disclosure may extend to surround the (1-1)-th and (1-2)-th electrodes 311 and 313 or the (2-1)-th and (2-2)-th electrodes 321 and 323 together at least two times.

On the other hand, the refractory insulation sheet 330 may be formed to further protrude in the first direction (i.e., the “X” direction or an opposite direction to the “X” direction) or a third direction (i.e., the “Y” direction or an opposite direction to the “Y” direction) that is perpendicular to the first direction and the second direction in facing areas of the first electrode stack 310 and the second electrode stack 320.

More specifically, the refractory insulation sheet 330 may further protrude by a protrusion length “L” on opposite sides (in the “X” direction or an opposite direction to the “X” direction) in the first direction in facing areas of the first electrode stack 310 and the second electrode stack 320, and may further protrude by a protrusion width “W” on opposite sides (the “Y” direction or an opposite direction to the “Y” direction) in the third direction, respectively.

That is, the refractory insulation sheet 330 may protrude further than the first separator 315 and the second separator 325 in the first direction, in which the (1-1)-th electrode tab 312 or the (1-2)-th electrode tab 314 protrudes, and may protrude further than the first separator 315 and the second separator 325 in the third direction.

The refractory insulation sheet 330 may have a size that is greater than the size of one surface of the first separator 315, which faces the refractory insulation sheet 330, and the size of the one surface of the second separator 325, which faces the refractory insulation sheet 330.

More specifically, when viewed in the second direction, the sizes of the first and second separators 315 and 325 may be formed to be greater than the sizes of the (1-1)-th, (1-2)-th, (2-1)-th, and (2-2)-th electrodes 311, 313, 321, and 323, and may be configured to be smaller than the size of the refractory insulation sheet 330.

Furthermore, the refractory insulation sheet 330 may have a thickness that is greater than the thickness of the first separator 315 or the thickness of the second separator 325 with respect to the direction in which a plurality of electrode stacks 300 are stacked.

According to this structure, exchange of ions between the first electrode stack 310 and the second electrode stack 320 that are configured to face each other with the refractory insulation sheet 330 interposed therebetween may be relatively prevented, and thus, a thermal runaway may be prevented from occurring in the secondary battery 100 (see FIG. 1).

On the other hand, although not illustrated separately in the drawing, the refractory insulation sheet 330 may be configured to be longer than that illustrated in the drawing, and may extend between the first separator 315 and the second separator 325 to the outside of the first separator 315 and the second separator 325. For example, the refractory insulation sheet 330 may surround the first separator 315 and the second separator 325 on the outside of the first separator 315 and the second separator 325.

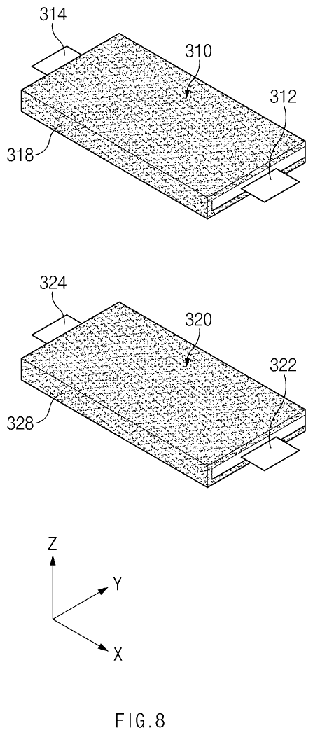

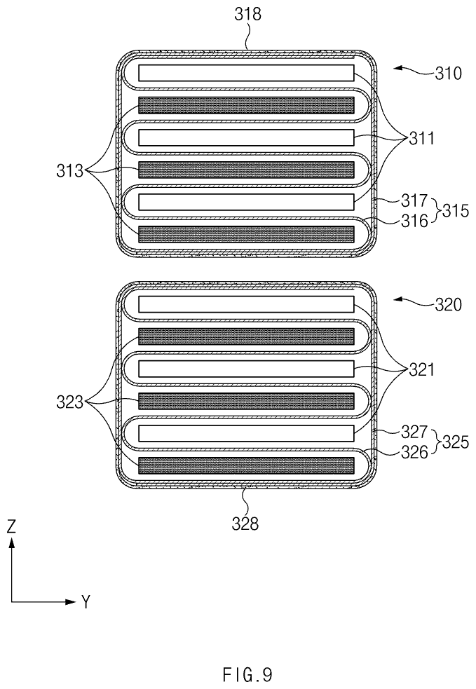

FIG. 8 is a perspective view of a first electrode stack and a second electrode stack according to another embodiment of the present disclosure. FIG. 9 is a vertical cross-sectional view of a first electrode stack and a second electrode stack according to another embodiment of the present disclosure.

Referring to FIGS. 8 and 9, each of the first and second electrode stacks 310 and 320 according to another embodiment of the present disclosure may include first and second cover sheets 318 and 328 that are disposed on the outside the first and second separators 315 and 325 and extend to surround the first and second separators 315 and 325.

For a description of the (1-1)-th, (1-2)-th, (2-1)-th, and (2-2)-th electrodes 311, 313, 321, and 323 according to another embodiment of the present disclosure, the descriptions of the (1-1)-th, (1-2)-th, (2-1)-th, and (2-2)-th electrodes 311, 313, 321, and 323 according to an embodiment of the present disclosure are used.

The first and second cover sheets 318 and 328 may be formed of a refractory insulation material, and may insulate the first and second electrode stacks 310 and 320, respectively.

For example, exchange of ions between the first electrode stack 310 and the second electrode stack 320 may be relatively prevented due to the configuration of the first and second cover sheets 318 and 328.

According to this structure, the first electrode stack 310 according to another embodiment of the present disclosure may include a first separator 315 that surrounds the (1-1)-th electrode 311 and the (1-2)-th electrode 313 at least one time on the outside, unlike the first electrode stack 310 according to an embodiment of the present disclosure.

The first separator 315 may include a (1-1)-th separator area 316 that is disposed between the (1-1)-th electrode 311 and the (1-2)-th electrode 313, and a (1-2)-th separator area 317 that extends from the (1-1)-th separator area 316 and is configured to surround the (1-1)-th electrode 311, the (1-2)-th electrode 313, and the (1-1)-th separator area 316 on the outside at least one time.

Due to the configuration of the first cover sheet 318, the (1-2)-th separator area 317 according to another embodiment of the present disclosure may surround the (1-1)-th electrode 311, the (1-2)-th electrode 313, and the (1-1)-th separator area 316 on the outside one time, unlike the (1-2)-th separator area 317 according to an embodiment of the present disclosure illustrated in FIG. 4.

Furthermore, in correspondence to the first electrode stack 310, the second separator 325 of the second electrode stack 320 may include a (2-1)-th separator area 326 that is disposed between the (2-1)-th electrode 321 and the (2-2)-th electrode 323, and a (2-2)-th separator area 327 that extends from the (2-1)-th separator area 326 and is configured to surround the (2-1)-th electrode 321, the (2-2)-th electrode 323, and the (2-1)-th separator area from the outside at least one time.

The (2-2)-th separator area 327 according to another embodiment of the present disclosure may surround the (2-1)-th electrode 321, the (2-2)-th electrode 323, and the (2-1)-th separator area 326 on the outside one time, unlike the (2-2)-th separator area 327 according to an embodiment of the present disclosure illustrated in FIG. 4, due to the configuration of the second cover sheet 328.

However, the present disclosure is not limited thereto, and the (1-2)-th and (2-2)-th separator areas 317 and 327 according to another embodiment of the present disclosure may extend to surround the (1-1)-th and (1-2)-th electrodes 311 and 313 or the (2-1)-th and (2-2)-th electrodes 321 and 323 together at least two times.

Each of the first and second cover sheets 318 and 328 may protrude further than the first and second separators 315 and 325 with respect to opposite sides in the first direction, from which the (1-1)-th electrode tab 312 or the second electrode tab 314 protrudes.

Even according to this structure, exchange of ions between the first and second electrode stacks 310 and 320 according to another embodiment of the present disclosure is relatively not performed, and thus, when a fire occurs in any one of the first and second electrode stacks 310 and 320, it is possible to prevent a thermal runaway through a thermal transfer in the other.

Accordingly, the safety of the secondary battery 100 (see FIG. 1) may be improved even by the structure of the electrode stack 300 according to the above-described embodiments of the present disclosure.

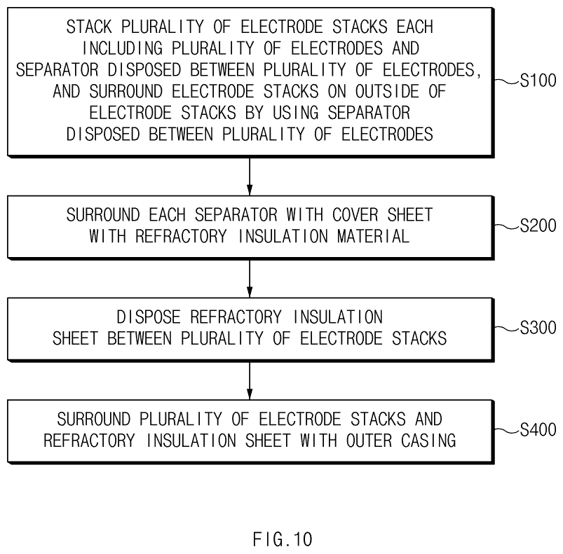

FIG. 10 is a flowchart of a method for manufacturing a secondary battery according to an embodiment of the present disclosure.

Referring to FIGS. 4, 6, 9, and 10, the method for manufacturing the secondary battery 100 (see FIG. 1) may include an operation S100 of stacking a plurality of electrode stacks 300 each including a plurality of electrodes 311, 313, 321, and 323, and a separator 315 and 325 that is disposed between the plurality of electrodes 311, 313, 321, and 323, and surrounding the electrode stacks 300 on an outside of the electrode stacks 300 by using the separator 315 and 325 disposed between the plurality of electrodes 311, 313, 321, and 323.

For example, because the size of the separator 315 and 325 may be greater than the sizes of the plurality of electrodes 311, 313, 321, and 323, the plurality of electrodes 311, 313, 321, and 323 may be surrounded on an outside of the plurality of electrodes 311, 313, 321, and 323 by using the separator 315 and 325 disposed between the plurality of electrodes 311, 313, 321, and 323. That is, the separator 315 and 325 may surround the electrode stacks, in which the plurality of electrodes 311, 313, 321, and 323 and the separator 315 and 325 are stacked.

The method for manufacturing the secondary battery 100 may further include an operation S200 of surrounding the separator 315 and 325 with a cover sheet 318 and 328 formed of a refractory insulation material after the separator 315 and 325 surrounds the electrode stack 300.

Meanwhile, the operation S200 of surrounding the separator 315 and 325 with the cover sheets 318 and 328 of the refractory insulation material may be selectively performed.

The method for manufacturing the secondary battery 100 may further include an operation S300 of disposing the refractory insulation sheet 330 between the plurality of electrode stacks 300.

The refractory insulation sheet 330 may be disposed between the plurality of electrode stacks 300 to contact all of the plurality of electrode stacks 300. According to the operations, exchange of ions between the plurality of electrode stacks that are configured to face each other with the refractory insulation sheet 330 interposed therebetween may be relatively prevented, and thus, a thermal runaway may be prevented from occurring in the secondary battery 100.

The method for manufacturing the secondary battery 100 may further include an operation S400 of surrounding the plurality of electrode stacks 300 and the refractory insulation sheet 330 with the outer casing.

According to the present technology, because the first electrode stack and the second electrode stack provided in the interior of the outer casing may be physically separated from each other, a thermal transfer or a thermal runaway between the first and second electrode stacks may be prevented, and thus, the safety of the secondary battery may be improved.

Besides, a variety of effects directly or indirectly understood through the present disclosure may be provided.

The above description is merely an example of the technical idea of the present disclosure, and various modifications and variations may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

What is claimed is:

1. A secondary battery comprising:
an outer casing;
a plurality of electrode stacks provided in an interior of the outer casing; and
a refractory insulation sheet disposed between the plurality of electrode stacks.

2. The secondary battery of claim 1, wherein the plurality of electrode stacks include:
a first electrode stack including:
a (1-1)-th electrode having a (1-1)-th electrode tab protruding to a first side;
a (1-2)-th electrode provided to have a different polarity from that of the (1-1)-th electrode and having a (1-2)-th electrode tab protruding to a second side; and
a first separator disposed between the (1-1)-th electrode and the (1-2)-th electrode and configured to surround the (1-1)-th electrode and the (1-2)-th electrode together on a first outside; and
a second electrode stack including:
a (2-1)-th electrode provided to have a polarity corresponding to the (1-1)-th electrode and having a (2-1)-th electrode tab protruding to the first side;
a (2-2)-th electrode provided to a different polarity from that of the (2-1)-th electrode and having a (2-2)-th electrode tab protruding to the second side; and
a second separator disposed between the (2-1)-th electrode and the (2-2)-th electrode and configured to surround the (2-1)-th electrode and the (2-2)-th electrode together on a second outside.

3. The secondary battery of claim 2, comprising:
a first lead part connected to the (1-1)-th electrode tab and the (2-1)-th electrode tab; and
a second lead part connected to the (1-2)-th electrode tab and the (2-2)-th electrode tab.

4. The secondary battery of claim 2, wherein the first separator extends to surround the (1-1)-th electrode and the (1-2)-th electrode together at least one time.

5. The secondary battery of claim 2, wherein the first separator extends to surround the (1-1)-th electrode and the (1-2)-th electrode together at least two times.

6. The secondary battery of claim 2, wherein the first separator includes:
a (1-1)-th separator area disposed between the (1-1)-th electrode and the (1-2)-th electrode; and
a (1-2)-th separator area extending from the (1-1)-th separator area and configured to surround the (1-1)-th electrode, the (1-2)-th electrode, and the (1-1)-th separator area together on an outside.

7. The secondary battery of claim 6, wherein the (1-2)-th separator area includes:
a (1-2)-th inner separator area connected to the (1-1)-th separator area; and
a (1-2)-th outer separator area extending from the (1-2)-th inner separator area and extending to surround the (1-2)-th inner separator area on an outside of the (1-2)-th inner separator area.

8. The secondary battery of claim 2, wherein the refractory insulation sheet has a size being greater than a first size of a surface of the first separator, which faces the refractory insulation sheet, and a second size of a surface of the second separator, which faces the refractory insulation sheet.

9. The secondary battery of claim 2, wherein the refractory insulation sheet protrudes further than the first separator and the second separator with respect to a first direction, in which the (1-1)-th electrode tab or the (1-2)-th electrode tab protrudes, and protrudes further than the first separator and the second separator with respect to a second direction crossing the first direction.

10. The secondary battery of claim 2, wherein the refractory insulation sheet has a first thickness being greater than a second thickness of the first separator or a third thickness of the second separator with respect to a direction in which the plurality of electrode stacks is stacked.

11. The secondary battery of claim 2, wherein the first electrode stack further includes a cover sheet disposed on a third outside of the first separator and extending to surround the first separator.

12. The secondary battery of claim 11, wherein the cover sheet protrudes further than the first separator with respect to a first direction, in which the (1-1)-th electrode tab or the (1-2)-th electrode tab protrudes.

13. The secondary battery of claim 11, wherein the cover sheet is formed of a refractory insulation material.

14. The secondary battery of claim 1, wherein the outer casing includes a pouch type outer casing.

15. The secondary battery of claim 2, wherein the refractory insulation sheet surrounds the first separator and the second separator on an outside of the first separator and the second separator.

16. A method for manufacturing a secondary battery, the method comprising:
stacking a plurality of electrode stacks each including a plurality of electrodes and a separator disposed between the plurality of electrodes, and surrounding the electrode stacks on an outside of the electrode stacks by using the separators disposed between the plurality of electrodes;
disposing a refractory insulation sheet between the plurality of electrode stacks; and
surrounding the plurality of electrode stacks and the refractory insulation sheet with an outer casing.

17. The method of claim 16, wherein the plurality of electrode stacks further include a cover sheet disposed on an outside of the separator and configured to surround the separator, and
wherein the method further includes surrounding the separator with the cover sheet after the separator surrounds the electrode stacks.

18. A secondary battery, comprising:
an outer casing;
a first electrode stack provided in an interior of the outer casing,
wherein:
the first electrode stack comprises:
a first electrode comprising a first electrode tab;
a second electrode comprising a second electrode tab; and
a first separator disposed, in part, between the first electrode and the second electrode, and
the first electrode and the second electrode have different polarities; and
a second electrode stack provided in the interior of the outer casing,
wherein:
the second electrode stack comprises:
a third electrode comprising a third electrode tab;
a fourth electrode comprising a fourth electrode tab; and
a second separator disposed, in part, between the third electrode and the fourth electrode, and
the third electrode and the fourth electrode have different polarities.

19. The secondary battery of claim 18, further comprising a refractory insulation sheet disposed between the first electrode stack and the second electrode stack in the interior of the outer casing.

20. The secondary battery of claim 19, wherein the refractory insulation sheet has a size being greater than a first size of a first surface of the first separator, which faces the refractory insulation sheet, and a second size of a second surface of the second separator, which faces the refractory insulation sheet.
